(19) United States
(12) Patent Application Publication
(10) Pub. No.: US 2017/0310133 A1
(43) Pub. Date: Oct. 26, 2017

(54) Powered Toolbox

(71) Applicant: GM Global Technology Operations LLC, Detroit, MI (US)

(72) Inventor: Nicole T. Bickley, Farmington Hills, MI (US)

(21) Appl. No.: 15/134,610

(22) Filed: Apr. 21, 2016

(51) Int. Cl. H02J 7/00; B25H 3/02

(52) U.S. Cl. CPC H02J 7/0044; B25H 3/02

(57) ABSTRACT

A powered container apparatus is provided. The powered container apparatus includes a container configured to hold an item; an attachment and detachment part configured to attach and detach the container to and from a vehicle; a first electrical interface configured to receive power from a power source of the vehicle; and a second electrical interface configured to charge the item at the container by using the received power. The powered container apparatus may be used in a vehicle configured to be detachably connected to the vehicle.

### INTRODUCTION

Apparatuses consistent with exemplary embodiments relate to toolboxes or containers. More particularly, apparatuses consistent with exemplary embodiments relate to toolboxes or containers that are attachable to objects.

### SUMMARY

One or more exemplary embodiments provide a powered toolbox or container configured to be attachable to a vehicle so as to be temporarily fixed to the vehicle. More particularly, one or more exemplary embodiments provide a powered toolbox or container that includes an electrical interface providing electrical power to charge an item, tool, or battery that is being stored in the toolbox or container and an electrical interface that receives electrical power from an electrical power source.

According an aspect of an exemplary embodiment, a powered container apparatus is provided. The powered container apparatus includes: a container configured to hold an item; an attachment and detachment part configured to attach and detach the container to and from a vehicle; a first electrical interface configured to receive power from a power source of the vehicle; and a second electrical interface configured to charge the item at the container by using the received power.

The container may include a holder configured in a shape to accommodate a tool or a battery.

The attachment and detachment part may include at least one from among a snap to lock mechanism, a sliding rail mechanism, and a latching mechanism.

The powered container apparatus may also include power converting device configured to convert the received power.

The power converting device may be connected to the first electrical interface and the second electrical interface.

One or both of the first electrical interface and the second electrical interface may be a wireless charging interface.

The first electrical interface may be configured to receive at least one from among direct current electricity and alternating current electricity.

The second electrical interface may be configured to provide at least one from among direct current electricity and alternating current electricity.

The powered container apparatus may further include a handle.

The powered container apparatus may further include a cover part configured to cover the container.

According an aspect of another exemplary embodiment, a portable vehicle storage and charging system is provided. The system includes a container configured to hold an item; a vehicle configured to be detachably connected to the container; an attachment and detachment part configured to attach and detach the container to and from the vehicle; a first electrical interface configured to receive power from a power source of the vehicle; and a second electrical interface configured to charge the item by using the received power.

The container may include a holder configured in a shape to accommodate a tool or a battery.

The attachment and detachment part may include at least one from among a snap to lock mechanism, a sliding rail mechanism, and a latching mechanism.

The vehicle and/or the container may include a power converting device configured to convert the received power.

The container may include a power converting device connected to the first electrical interface and the second electrical interface.

At least one from among the first electrical interface and the second electrical interface may be a wireless charging interface.

The first electrical interface may be configured to receive at least one from among direct current electricity and alternating current electricity.

The second electrical interface may be configured to provide at least one from among direct current electricity and alternating current electricity.

The container may further include a handle.

The container may further include a cover part configured to cover the container.

Other objects, advantages and novel features of the exemplary embodiments will become more apparent from the following detailed description of exemplary embodiments and the accompanying drawings.

### BRIEF DESCRIPTION OF THE DRAWINGS

FIG. 1A shows view of the powered toolbox according to an exemplary embodiment;

FIG. 1B shows view of an interior of the powered toolbox according to an exemplary embodiment;

FIG. 2 shows a perspective view of the powered toolbox in a storage box attached to a bed of vehicle according to an aspect of an exemplary embodiment;

FIG. 3 shows a perspective view of a tray in a storage box configured to accommodate the powered toolbox in a vehicle according to an aspect of an exemplary embodiment; and

FIG. 4 shows a diagram of attaching and detaching the powered toolbox from the tray.

### DETAILED DESCRIPTION

Vehicles such as trucks and sport utility vehicles are commonly used to transport and store items such as tools and toolboxes. A toolbox or container is used to store multiple items and may be placed in a vehicle to transport the items.

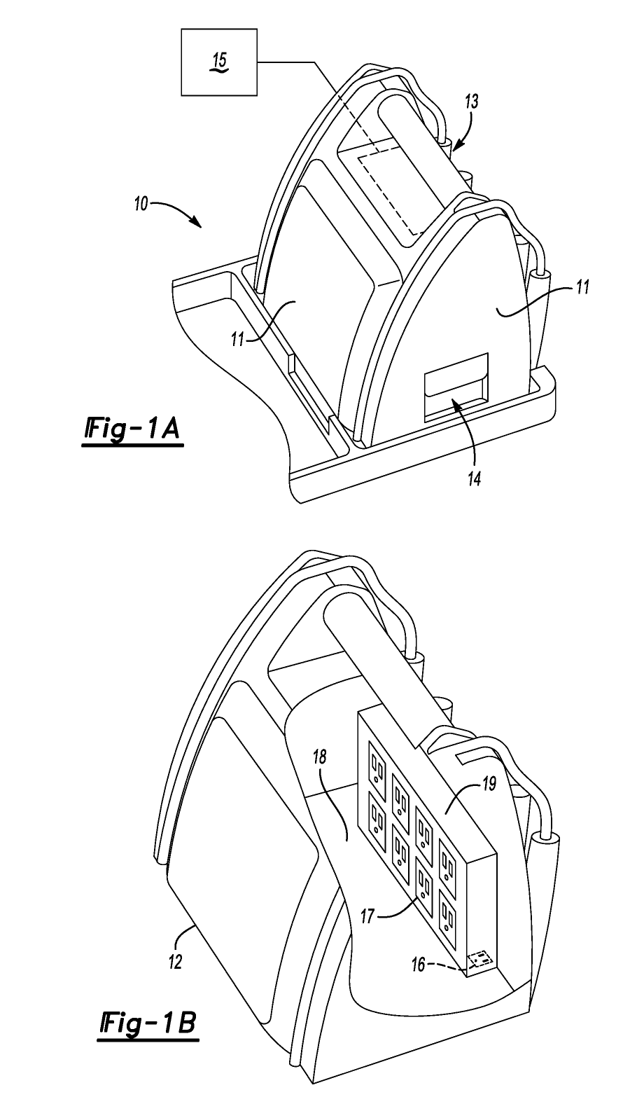

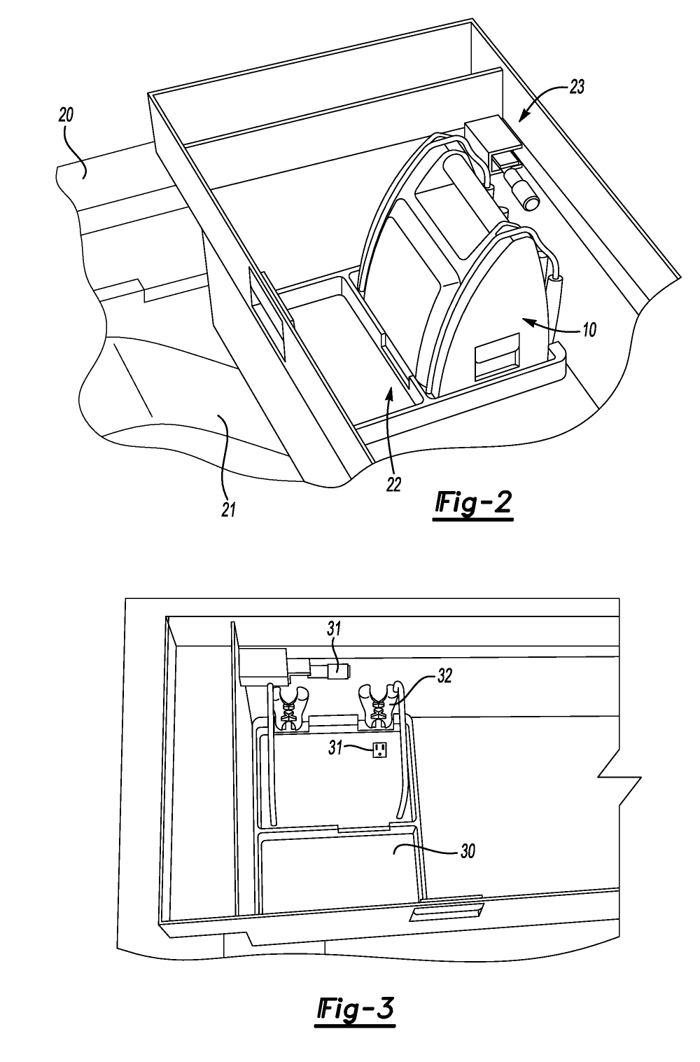

A powered toolbox (e.g., a powered container) will now be described in detail with reference to FIGS. 1-4 of the accompanying drawings in which like reference numerals refer to like elements throughout. The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “formed on,” or “disposed on” a second element, the first element may be connected directly to, formed directly on or disposed directly on the second element or there may be intervening elements between the first element and the second element, unless it is stated that a first element is “directly” connected to, formed on, or disposed on the second element.

FIG. 1A shows view of the powered toolbox 10 according to an exemplary embodiment. The powered toolbox 10 may be one of a portable container, a portable carrying case, or other portable object configured to hold items such as tools, batteries, electronic devices, etc. In addition, a bed storage box or storage bin may be a powered toolbox 10 or a powered toolbox 10 may be configured to be attachable to a bed storage box or storage bin. According to an exemplary embodiment, the powered toolbox 10 may be waterproof or water tight, for example, by incorporating a water tight seal on surfaces that run along openings that contact cover part 15 such as a cover, cap or lid of the powered toolbox 10. The water tight seal may be made of a rubber, silicon or other water resistant compound.

The powered toolbox 10 may comprise panels 11 made with one or more of metals, plastics, composites, fiberglass, laminated sheets, reinforced materials, insulating materials, honeycomb structure, or other material or structure. The powered toolbox 10 may also comprise a base 12 and a handle 13. In addition, the powered toolbox 10 may include one or more covers, caps or lids 15. The cover part 15 may be configured to keep the cover, cap or lid closed by using one or more of a clasp, a latching mechanism, a magnetic fastener, a key or combination lock mechanism, etc. However, the powered toolbox 10 does not have to include a cover part 15 and may be open from the top or one or more sides.

One or more of the panels 11, the base 12 and the cover part 15 of the powered toolbox 10 may include an attachment and detachment part 14. The attachment and attachment and detachment part 14 may include one or more of a snap to lock mechanism, a sliding rail mechanism, a magnetic fastener, a hook and loop fastener, a hook, a clasp and a latching mechanism. The attachment and detachment part 14 may use one or more of the aforementioned components to attach and detach the powered toolbox 10 to an object such as a vehicle. A snap to lock mechanism may include projections disposed on the powered toolbox 10 that snap into recesses located on the vehicle, or vice versa. A sliding rail mechanism may include slide rails disposed on the powered toolbox 10 that are configured to slide into a channel located on a vehicle, or vice versa. The latching mechanism may include latches disposed on the powered toolbox 10 that are configured to lock onto a projection located on a vehicle, or vice versa.

FIG. 1B shows view of an interior of the powered toolbox according to an exemplary embodiment. Referring to FIG. 1B, the powered toolbox 10 may include a holder 18 configured in a shape to accommodate a tool or a battery. The holder 18 may be at least one from among a chamber, a cavity, a socket, a mold, and a slot. The holder 18 may be disposed or formed at an internal part of the powered toolbox 10 or disposed or formed on an external part of the powered toolbox 10.

The powered toolbox 10 may also include a power converting device 19 configured to convert alternating current electricity to direct current electricity, or vice versa. For example, the power converting device 19 may include a power inverter configured to convert direct current electricity to alternating current electricity.

In addition, the power converting device 19 may include one or more of a transformer, a rectifier, a filter, and a regulator. The transformer may be configured to step down the input voltage and output an alternating current signal to the rectifier. The rectifier may be configured to convert the alternating current signal to a direct current signal using rectification. The filter may be configured to smooth the output of the rectifier by filtering ripples from the rectification and output a filtered signal. The regulator may be configured to output a steady signal based on the filtered signal.

The power converting device 19 may part of the powered toolbox 10 and may be connected to a first electrical interface 16 (described below) and a second electrical interface 17 (described below) or may be attached to a vehicle connected to the powered toolbox through the first electrical interface 16 (described below).

The powered toolbox 10 may include a first electrical interface 16 and a second electrical interface 17. The first electrical interface 16 and second electrical interface 17 may be one or more of a connector, wire, plug, outlet, wireless charging matt, inductive charging device, terminal, port, etc. The first electrical interface 16 may be configured to receive power from the vehicle or power source such as a battery in the powered toolbox 10 and transfer the power to the second electrical interface 17 to charge one or more items through the powered toolbox 10. The second electrical interface 17 may be configured to charge one or more items through the powered toolbox 10.

According to an exemplary embodiment, the first electrical interface 16 and second electrical interface 17 may be interfaces comprising one or more of a universal serial bus (USB), a lighting interface, a 110v-240v electrical outlet, an electrical outlet, a wireless charging interface, and a Qi pad and receiver.

FIG. 2 shows a perspective view of the powered toolbox 10 attached to a bed 21 of vehicle 20 according to an aspect of an exemplary embodiment. In FIG. 2, the powered toolbox 10 is placed on a tray 22 in a storage box 23 in the bed 21 of the vehicle 20. However, the powered toolbox 10 may be placed in a slot, slid into channels configured to accommodate rails of the powered toolbox 10, attached to a hook, or attached to other means designed to secure the powered toolbox 10 to the vehicle 20. The tray 22 may include a vehicle power source 31 such as a connector, wire, plug, outlet, wireless charging matt, inductive charging device, terminal, port, etc., configured to provide power to the first electrical interface 16 of the powered toolbox 10. Alternatively, the vehicle power source 31 may be placed in the storage box 23, the bed 21, or another location of the vehicle 20.

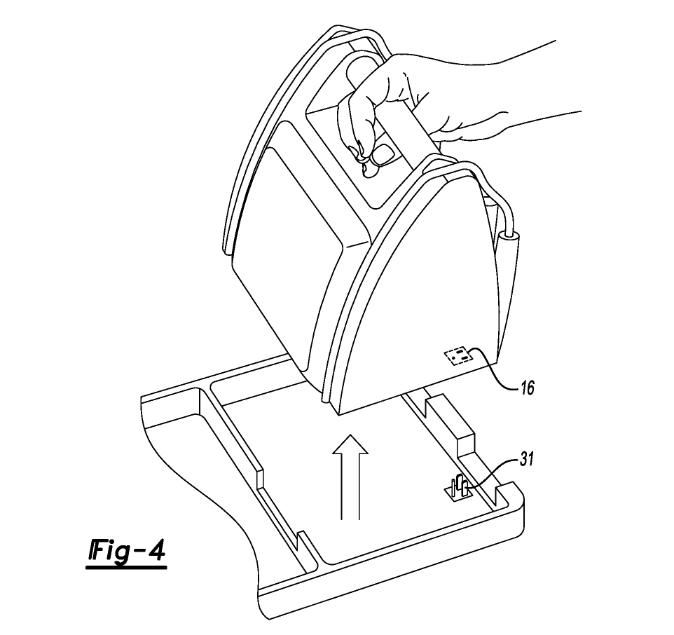

FIG. 3 shows a perspective view of a tray 30 configured to accommodate the powered toolbox 10 in a vehicle 20 according to an aspect of an exemplary embodiment. The tray 30 may be formed in a shape to accommodate the powered toolbox 10. The tray 30 may also be formed in a shape to accommodate multiple powered toolboxes 10. The tray 30 may also include an attachment and detachment part configured to temporarily fix or lock the powered toolbox 10 to the tray 30. The tray 30 may be fixed to a trunk or a bed 21 of a vehicle 20. In an exemplary embodiment, the tray may include jumper cables 32 that may be used to recharge another vehicle's battery.

FIG. 4 shows a diagram of attaching and detaching the powered toolbox from the tray. Referring to FIG. 4, the first electrical interface 16 may be connected to the vehicle power source 31. If the powered toolbox 10 is lifted, the first electrical interface 16 may be disconnected from the vehicle power source 31 as part of an attaching and detaching process. The attaching and detaching process may include causing the attachment and detachment part 14 to release the powered toolbox 10 from the tray. Moreover, audio, visual or mechanical feedback may be provided when the powered toolbox 10 is re-attached to or detached from the tray 30 and the vehicle power source 31 to indicate that the powered toolbox 10 is secure and connected to the power. The feedback may be in the form of a light, display, chime, or click of a latch. The feedback may be provided by a device in the interior or exterior of the vehicle.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A portable vehicle storage and charging system comprising:
a container configured to hold an item;
a vehicle configured to be detachably connected to the container;
an attachment and detachment part configured to attach and detach the container to and from the vehicle;
a first electrical interface configured to receive power from a power source of the vehicle; and
a second electrical interface configured to charge the item at the container by using the received power.

2. The system of claim 1, wherein the container comprises a holder configured in a shape to accommodate a tool or a battery.

3. The system of claim 1, wherein the attachment and detachment part comprises at least one from among a snap to lock mechanism, a sliding rail mechanism, a magnetic fastener, a hook and loop fastener, a hook, a clasp, and a latching mechanism.

4. The system of claim 1, wherein at least one from the vehicle and the container comprises a power converting device.

5. The system of claim 1, wherein the container comprises a power converting device connected to the first electrical interface and the second electrical interface.

6. The system of claim 1, wherein at least one from among the first electrical interface and the second electrical interface is a wireless charging interface.

7. The system of claim 1, wherein the first electrical interface is configured to receive at least one from among direct current electricity and alternating current electricity.

8. The system of claim 1, wherein the second electrical interface is configured to provide at least one from among direct current electricity and alternating current electricity.

9. The system of claim 1, wherein the container further comprises a handle.

10. The system of claim 1, wherein the container further comprises a cover part configured to cover the container.

11. A powered container apparatus comprising:
a container configured to hold an item;
an attachment and detachment part configured to attach and detach the container to and from a vehicle;
a first electrical interface configured to receive power from a power source of the vehicle; and
a second electrical interface configured to charge the item at the container by using the received power.

12. The apparatus of claim 11, wherein the container comprises a holder configured in a shape to accommodate a tool or a battery.

13. The apparatus of claim 11, wherein the attachment and detachment part comprises at least one from among a snap to lock mechanism, a sliding rail mechanism, a magnetic fastener, a hook and loop fastener, a hook, a clasp and a latching mechanism.

14. The apparatus of claim 11, further comprising a power converting device configured to convert the received power.

15. The apparatus of claim 14, wherein the power converting device is connected to the first electrical interface and the second electrical interface.

16. The apparatus of claim 11, wherein at least one from among the first electrical interface and the second electrical interface is a wireless charging interface.

17. The apparatus of claim 11, wherein the first electrical interface is configured to receive at least one from among direct current electricity and alternating current electricity.

18. The apparatus of claim 11, wherein the second electrical interface is configured to provide at least one from among direct current electricity and alternating current electricity.

19. The apparatus of claim 11, further comprising a handle.

20. The apparatus of claim 11, further comprising a cover part configured to cover the container.
